(19) United States
(12) Patent Application Publication
(10) Pub. No.: US 2006/0046238 A1
(43) Pub. Date: Mar. 2, 2006

(54) System and method for collecting and analyzing behavioral data

(76) Inventors: Karen DeGregory, Sudbury, MA (US); Karen Mahon, Waltham, MA (US); David Pasterchik, Sudbury, MA (US)

Correspondence Address: Linda M. Beach, 3602 Midfield Way, Redwood City, CA, 94062, US

(21) Appl. No.: 11/215,557

(22) Filed: Aug. 29, 2005

Related U.S. Application Data
(60) Provisional application No. 60/606,166, filed on Aug. 30, 2004.

(51) Int. Cl. G09B 3/00

(52) U.S. Cl. 434/350

(57) ABSTRACT

The invention is directed to techniques for techniques for collecting, analyzing and reporting behavioral data through the use of electronic devices such as personal data assistants (PDAs) and computers. The invention provides functional behavior assessment and analysis tools, and a means for examining and building communication behaviors. Sequential analyses are used to provide information about events that tend to occur together, suggesting areas of focus for students' behavior plans. Customization tools and an interactive training program in how to use the tool are also provided.

### CROSS-REFERENCE TO RELATED APPLICATIONS

This application claims priority from co-pending U.S. Provisional Patent Application No. 60/606,166 filed Aug. 30, 2004, entitled SYSTEMS AND METHODS FOR COLLECTING AND ANALYZING BEHAVIORAL DATA which is hereby incorporated by reference, as if set forth in full in this document, for all purposes.

### BACKGROUND

Government mandated special education programs (IDEA 2004) require that when a child with a disability violates a code of student conduct a manifestation determination, including a functional behavioral assessment, must be done before a change in placement can be made. If the behavior is determined to be a manifestation of the disability, then behavioral intervention services and modifications, that are designed to address the behavior violation must be provided to the student in their current placement. Performing a functional behavioral assessment requires that data on the student's behavior be collected at regular intervals, often daily. Behavioral data are typically collected on paper worksheets that are filled out by the teacher. Each instance of a particular behavior that is being tracked is written down on the worksheet. Six relevant pieces of data are tracked for each behavior: the antecedent to the behavior, the behavior itself, may be followed by the consequence that follows the behavior, duration of the behavior, communication events associated with the behavior, and key characteristics of the environment in which the behavior occurred (including time of day).

For example, consider the following sequence of events: (1) the teacher asks a child to complete an assignment; (2) the child starts screaming; and (3) the teacher goes over to the child to try to calm him down. The behavior of “screaming” is preceded by an antecedent in the form of a demand (request to complete an assignment) and followed by a consequence in the form of attention (the child gets attention from the teacher). Over the course of a day, numerous instances of behavior can occur, requiring the teacher to fill out numerous entries on the behavior-tracking worksheets. It can be difficult for a teacher to keep up with entering all of this data while at the same time teaching a class of students. This can lead to inaccurate data and the omission of valuable data that could be used for evaluating both the student's progress and the teacher's success in implementing the student's IEP.

The worksheets provide valuable information that is examined by a person who has the skills to analyze the data in order to determine whether the IEP is working and what changes need to be made to the IEP based on these analyses. Typically this person is a highly specialized consultant. In an era where school budgets are continually being reduced due to local, state and federal budget deficits and bad economic times, there is a need for less costly and more efficient ways to implement these government mandated special-education programs.

### SUMMARY

The present invention relates to a system and method for collecting and analyzing behavioral data that provide advantages over conventional approaches. The conventional approach for collecting and analyzing data relating to a student's individualized education program (IEP) often requires consultants to be hired. These consultants observe a student, write down information about that student's behavior on paper worksheets, and analyze the data for meaning. These activities are usually not carried out by teachers because teachers typically do not have the training to complete them. Even in the rare cases in which teachers do have the appropriate training, conducting these data collection and analysis activities are usually too time-consuming in light of other demands on the teacher's time and attention.

Conventional paper-and-pencil data collection and analysis methods are both time- and labor-intensive and therefore discourage extensive data collection. However, it is important to have sufficient data to analyze and make recommendations about student programs. The purpose of the software program described here is to provide a means for easy data collection that can be implemented by professionals and non-professionals (i.e., teachers, therapists, and parents) with minimal training. The software is intended to be user-friendly and to conduct the complex analyses that a consultant would normally be required to do. In contrast to the conventional paper-based approach, the invention is directed to techniques for collecting, analyzing and reporting behavioral data through the use of electronic devices such as personal data assistants (PDAs) and computers.

In addition to providing functional behavior assessment and analysis tools, the current program provides a means for examining and building communication behaviors. Put simply, once inappropriate behaviors have been determined to have a communication function (via the assessments and analyses provided by the tool), a plan to increase incompatible appropriate communication alternatives may be developed by the team. The appropriate-communication behaviors may then be measured using the tool, and the relation between the occurrence of inappropriate and appropriate communication behaviors may be examined as the program is implemented.

Although the primary data will be collected using a PDA, analysis portions of this tool's use will be conducted on a desktop computer in order to capitalize on the speed and power of that device. Mathematical computations, such as computing rates and durations of behaviors, as well as conducting analyses of the relations between sequential events will be conducted on a desktop computer. The sequential analyses, in particular, will be very informative to the users by providing information about events that tend to occur together, suggesting areas of focus for students' behavior plans.

In addition to providing complex data analyses, the desktop portion of the tool will provide an interactive training program in how to use the tool. The new user will view video clips of classroom events on the desktop monitor and simultaneously collect behavioral data on the attached PDA, using the actual data collection tool. The user will be given immediate feedback regarding the data that he/she collects. The user will be provided with recommended performance criteria to achieve in the training program prior to collecting real classroom data. In addition, recommendations for conducting occasional inter-observer agreement (i.e., reliability) sessions once real data collection has begun will be included in the package. The software program will have the ability to compute reliability based on data collected from multiple observers.

The desktop portion will also include a computer aided design tool which allows the user to customize contents of the lists (for example the activity, where the activity is taking place, whom the student is working with) which are then presented on the PDA during data collection.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating a system for collecting and analyzing behavioral data in accordance with an embodiment of the invention.

FIG. 2 is a flow diagram illustrating a method for collecting behavioral data in accordance with an embodiment of the invention.

FIG. 3 is a diagram illustrating a user interface for collecting behavioral information in accordance with an embodiment of the invention.

FIG. 4 is a diagram illustrating a user interface for collecting behavioral information in accordance with an embodiment of the invention.

FIG. 5 is a diagram illustrating a user interface for collecting behavioral information for multiple events in accordance with an embodiment of the invention.

FIG. 6 is a diagram illustrating a user interface for collecting behavioral information for multiple events in accordance with an embodiment of the invention.

FIG. 7 is a diagram illustrating a user interface for collecting communication behavior information in accordance with an embodiment of the invention.

FIG. 8 is a diagram illustrating a user interface for collecting communication behavior information in accordance with an embodiment of the invention.

FIG. 9 is a flow diagram illustrating a method for customizing a system for collecting behavioral information in accordance with an embodiment of the invention.

FIG. 10 is a flow diagram illustrating a method for analyzing behavioral data in accordance with an embodiment of the invention.

FIG. 11 is a flow diagram illustrating a method for automated instruction for a method for collecting and analyzing behavioral data in accordance with an embodiment of the invention.

FIG. 12 is a diagram illustrating a user interface for customizing a behavior recording form in a system for collecting behavioral data in accordance with an embodiment of the invention.

FIG. 13 is a diagram illustrating a user interface for customizing an observations setting form in a system for collecting behavioral data in accordance with an embodiment of the invention.

FIG. 14 is a diagram illustrating a user interface for customizing an additional communications form in a system for collecting behavioral data in accordance with an embodiment of the invention.

### DETAILED DESCRIPTION

The invention is directed to techniques for collecting, analyzing, and reporting behavioral data through the use of electronic devices such as personal data assistants (PDAs) and computers.

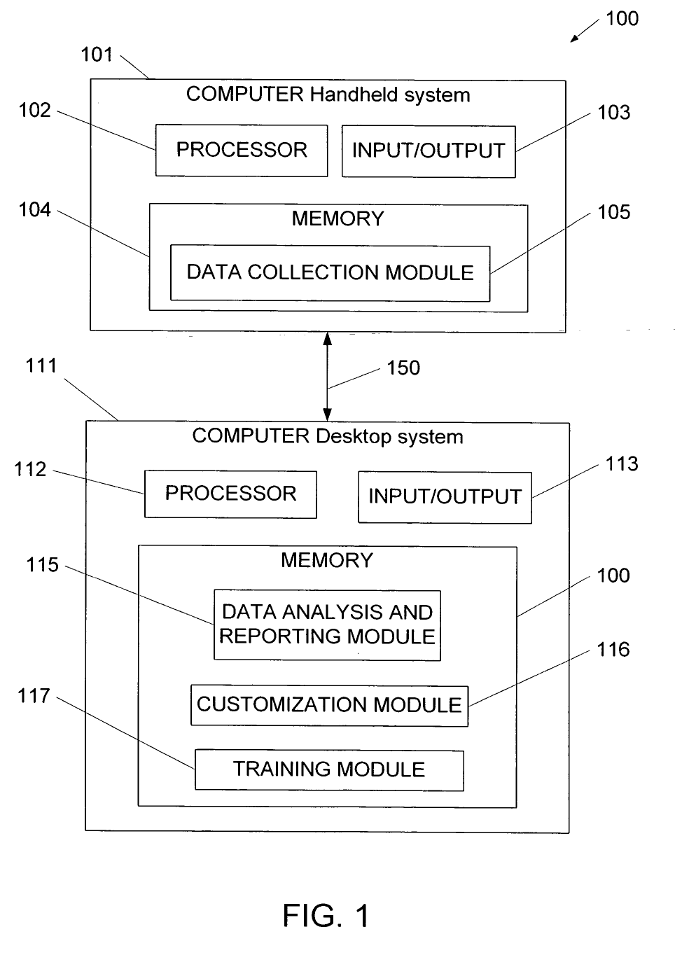

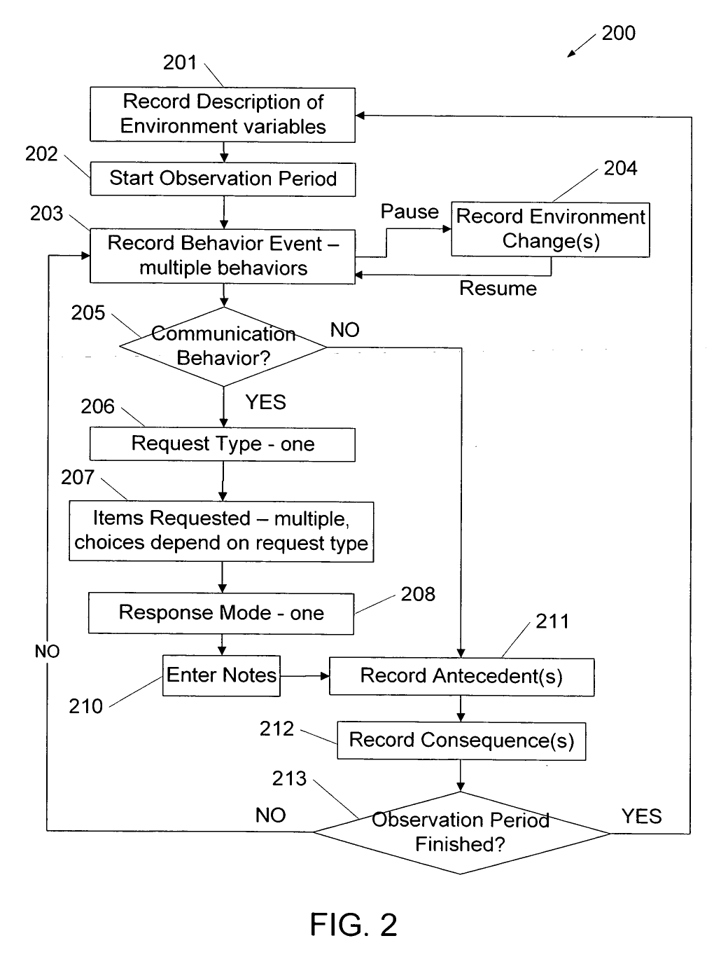

FIG. 1 is a block diagram 100 illustrating a system for collecting and analyzing behavioral data. In an embodiment of the invention, the system includes a portable system 101 for collecting behavioral data and a desktop system 111 for analyzing and reporting behavioral data, customization, and automated training. The system for collecting behavioral data 101 includes a processor 102, an input/output device 103 and memory 104. The memory includes a data collection module 105, which provides the functionality for implementing methods of collecting data that are described below in the discussion of FIGS. 2-8. The system for collecting behavioral data 101 can be implemented on a portable device such as a handheld PDA for convenience and ease of use. The data on the portable device can be uploaded to the desktop system for analyzing behavioral data 111 through any appropriate synchronization means 150 such as a USB connection and associated synchronization software. The synchronization means 150 could be a wired or a wireless connection. Through synchronization, data is shared between the two systems 101 and 111 so that if data is changed on one system it can be downloaded to the other, as is known in the field of personal data assistants (PDAs).

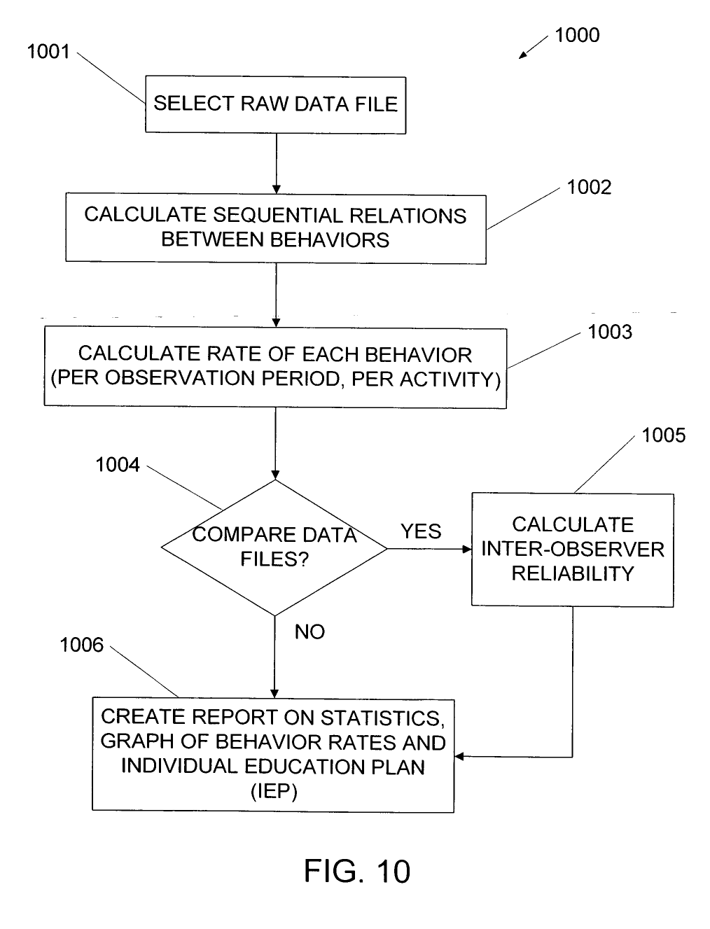

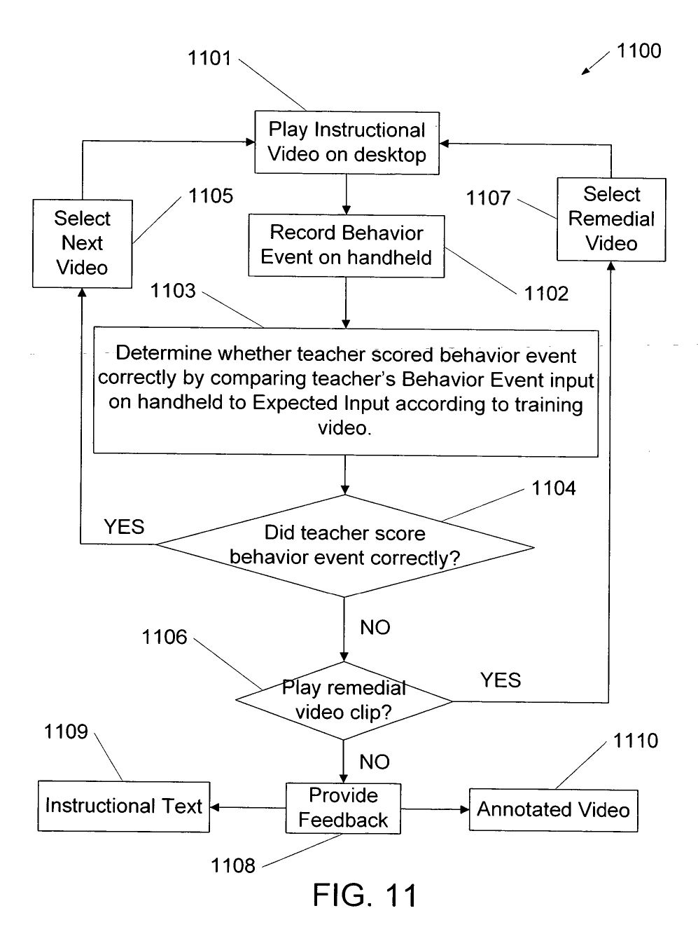

The system for analyzing behavioral data 111 includes a processor 112, an input/output device 113 and memory 114. The memory includes a data analysis and reporting module 115, a customization module 116 and an automated instruction module 117. In an embodiment of the invention, the data analysis and reporting module 115 operates in accordance with the method described in the discussion of FIG. 10 below. In an embodiment of the invention, the data analysis and reporting module 115 could be split up into two separate modules: a data analysis module and a reporting module. In an embodiment of the invention, the customization module 116 operates in accordance with the methods and user interfaces described in the discussion of FIGS. 2-8 below. In an embodiment of the invention, the automated instruction module 117 operates in accordance with the method described in the discussion of FIG. 11 below.

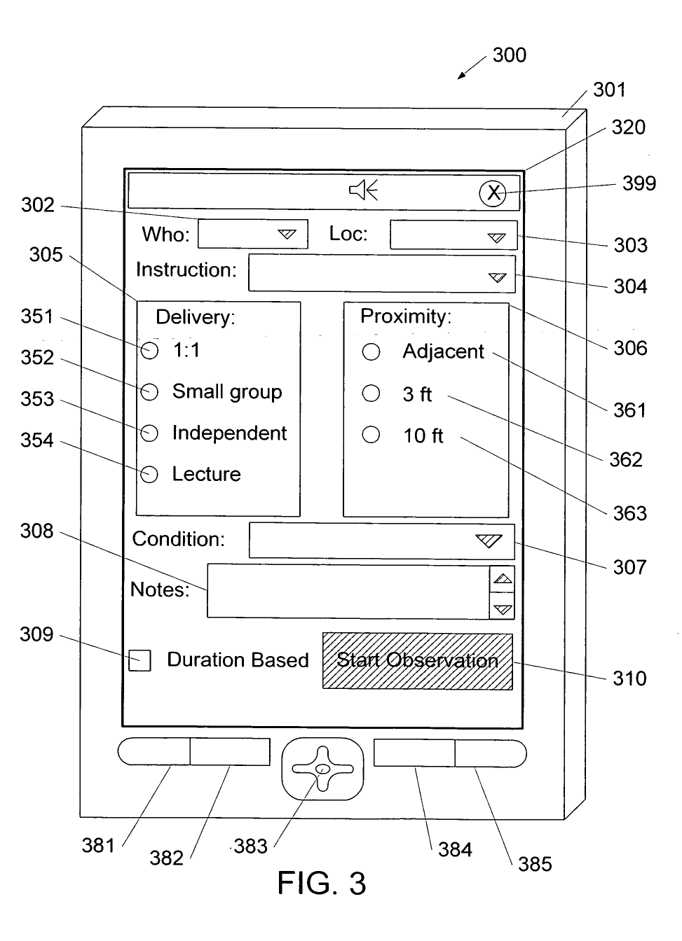

FIG. 2 is a flow diagram 200 illustrating a method for collecting behavioral data in accordance with an embodiment of the invention. A description of environmental variables are recorded, step 201, in order to set up the parameters for data collection. Examples of typical environmental variables include the following: information about the person who is working with the student (typically a teacher), the location of the data collection, the type of instruction being given at the time of data collection, the delivery method, the data collector's proximity to the student, notes, and whether the measurement of behaviors is event-based or duration-based. The environmental variables can be implemented in a system for collecting behavioral data having a user interface as shown and described in FIG. 3.

The behavioral data are collected over a period of time called an observation period. This is the period of time over which the student is observed and information about his behavior is collected. The length of the observation period can be a predetermined period of time, or a desired length of time as determined by the user who is collecting the data. The observation period is started, step 202, and at least one behavior event is recorded, step 203. Multiple co-occuring behaviors can be recorded and associated with one event. If the environmental change option is selected, the behavior event recording can be paused, the environmental changes can be input to the system, step 204, and then recording can resume, step 203.

A check for communication behavior is performed, step 205, and if communication behavior is not detected, then processing continues at step 211 where the antecedent to the behavior is recorded. Otherwise, if communication behavior is detected, a request type is input, step 206. Examples of request types include a request for attention, a request for a break, a tangible request and a sensory request. A tangible request is a request made by a student whereby the student indicates that he wants an object to be given to him, i.e. a tangible. A request for a tangible can be a request for an item such as food, drink, candy, a toy, or any other tangible item. Similarly, a sensory request is a request made by a student whereby the student indicates that he wants a particular sensory experience (e.g. a weighted blanket, tickles, etc.). The items requested are entered as input, step 207, and depending on the request type selected in step 206, there can be multiple items associated with the particular request type.

After entering a request type and items requested, a response mode input is entered, step 208. A response mode refers to the student's response and can be, for example, a vocal response, a gesture such as pointing, or a picture. The picture exchange response mode is selected when the student responds using a communication book, such as when the student presents a picture or icon representing the item that the student wants to obtain. For example, if the student makes a request for an apple (a tangible request for a food item), he would give a picture with the symbol for “apple” on it to the person who is collecting the data. This is an example of a picture exchange behavior. Notes can be entered, step 210, to introduce additional information and to clarify what has already been entered.

The antecedent to the behavior is entered, step 211, and the consequence to the behavior is entered, step 212. At decision point 213, a determination is made as to whether the observation period is finished. If the observation period is finished, then a new set of environmental variables can be entered, step 201 and a new observation period can be started, step 202. If the observation period is not finished, then processing continues at step 203 where another behavior event is recorded.

FIG. 3 is a diagram illustrating a system 300 for collecting behavioral information in accordance with an embodiment of the invention. A data collection method in accordance with an embodiment of the invention is implemented on a handheld device 301. In an embodiment of the present invention, handheld device 301 includes a display 320. The user interface on the display is used for entering data, as described below. The display 320 can be an interactive display as found in typical PDAs, which provide the user to interact with the device by touching or pressing on areas of the display with an implement such as a pointing device. In an embodiment of the invention, a display 320 without such touchscreen capabilities could also be used. For example, the functionality can be implement by input means such as buttons 381-385 to carry out the data collection. Alternatively, handheld device 301 can provide both input means so that the user can decide which he prefers to use.

At or before the start of the observation period (step 202), a plurality of environmental variables can be entered into the handheld (step 201) through the user interface. Information about who is working with the student can be entered at dropdown list 302, and include the name of a person, their title, or any other identifying indicator that will allow the data entered by that person to be differentiated from data that is entered by another person. This information is useful in determining whether the student behaves differently for different people. This can be useful for example, in determining whether the student behaves better with his parents than with his teachers or vice versa. The contents of all dropdown lists presented on the PDA are customizable via the desktop computer-aided design tool.

Location information can be entered at dropdown list 303. The location information includes various contexts in which data collection might desirably occur, for example, at home, in the classroom, in a school cafeteria, or in a supermarket. Instructional information can be entered at dropdown list 304. This provides information about the type of instruction being given to the student at the time of data collection. The instruction can include various school subjects such as reading, mathematics, physical education, and ADL.

The user interface also includes a data input module 305 that can include a plurality of radio buttons 305 through which the relevant delivery method of the instruction can be entered. The delivery method examples shown include “1:1” instruction (one teacher with one student) 351, “Small group” 352, “Independent” 353 and “Lecture” 354 instruction. The user interface also includes a data input module 306 that can include a plurality of radio buttons 306 by which relevant proximity information can be entered. Proximity information relates to how far apart the student is from the person giving the instruction. As shown in FIG. 3, the user interface has been customized to include radio buttons through which the options of “Adjacent” 361, “3 feet” 362 and “10 feet” 363 can be selected. Note that customization of the user interface, described further below, can change the specific items that are included in the user interface.

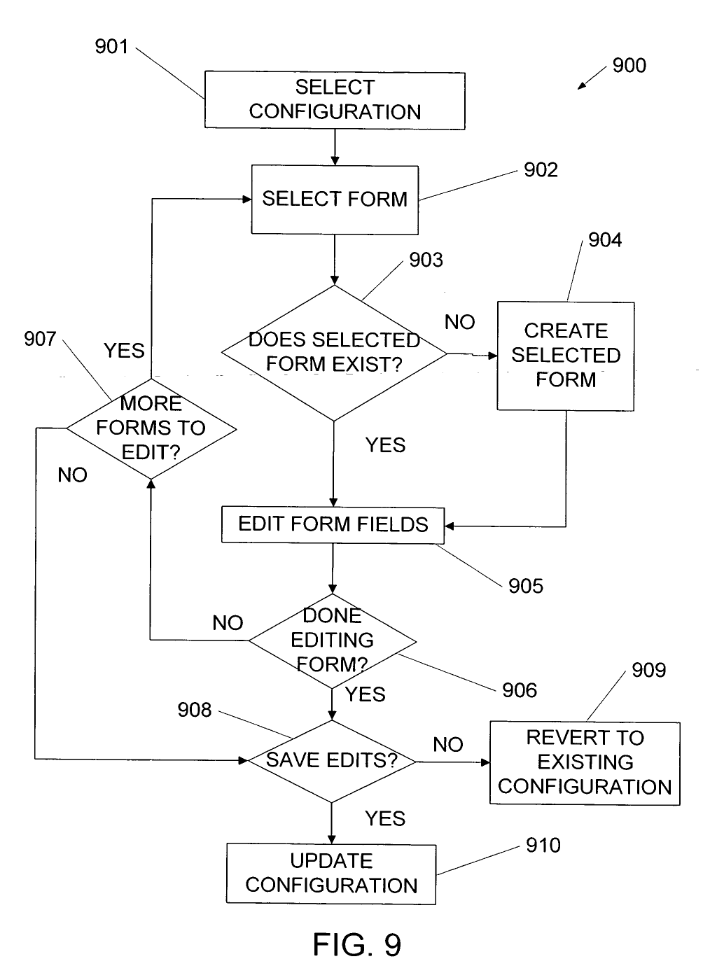

The user interface also includes a dropdown list 307 for entering condition information that is relevant to functional analyses. This condition information is used to indicate how the environment has been manipulated to test an hypothesis generated from a functional assessment. The list can include a plurality of conditions that can be labeled in an arbitrary manner, such as Condition A, Condition B, Condition C, etc. Similar to the other dropdown lists and radio buttons described above, dropdown list 307 can also be customized using a system and method for customizing an event data recording apparatus in accordance with an embodiment of the invention, described further below in the discussion of FIG. 9.

Notes can be entered in field 308 as desired, in order to add information that is not readily obtainable through the other data entry points shown. Although shown as a scrollable text box, it could be implemented in any appropriate fashion known to persons having skill in the art.

At the bottom left corner of the user interface shown in FIG. 3, a selection means such as a checkbox 309 associated with “Duration based” behavior data can be selected in order to cause the analysis of the behavior data to be duration-based rather than event-based. The default in the particular example configuration shown is that the analysis of the behavior data is to be event-based. In an embodiment of the invention, both a selection means associated with duration-based behavior and a selection means associated with event-based behavior can be implemented, rather than assuming that one or the other is the default setting.

In order to start the actual data collection period, the “Start Observation” button 310 is selected. The “Start Observation” button 310 is marked with hash marks to indicate that it is active and selectable.

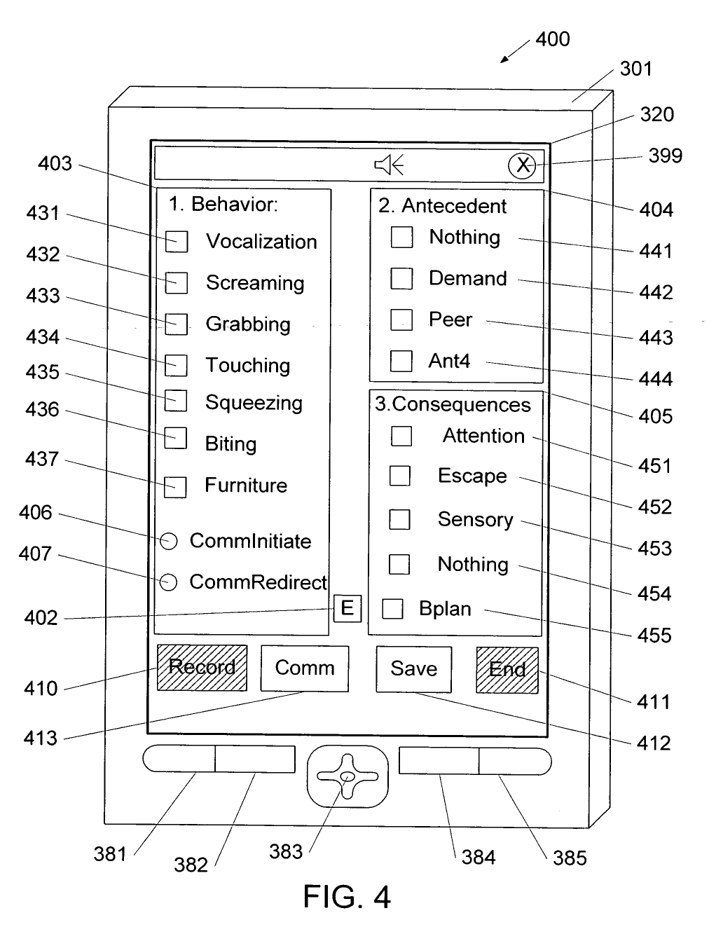

FIG. 4 is a diagram illustrating a system 400 for collecting behavioral information in accordance with an embodiment of the invention, and is shown as being implemented through a user interface on a handheld device 301. The user interface shown is the “Record Event” screen. The “Record Event” screen includes a plurality of selectable elements that are useful for recording events. The buttons 410-413 located at the bottom of the screen are shown as having hash marks when they are active and can be selected. The buttons 410-413 are shown as not having hash marks when they are not active and cannot be selected. In this particular example, the “Record” button 410 and the “End” button are active, and the “Comm” button 413 and the “Save” button are inactive. Although the means for differentiating active vs. inactive buttons is shown in FIG. 4 by the presence or absence of hash marks, it is known in the art that such means can be implemented in a variety of ways. For example, in an embodiment of the invention, this can be implemented by using bold text to indicate that a button is active and by using grayed out text to indicate that the button is not active.

During an observation, information can be collected for multiple events. An observation period is started by selecting the “Record” button 410, at which point a time stamp associated with the beginning of the observation period is recorded. The observation period is ended by selecting the “End” button 411, at which point a time stamp associated with the ending of the observation period is recorded. The “End” button 411 is also used to stop the program. Time stamps for the beginning and end of each event is also recorded along with information about the antecedents and consequences. The “Save” button 412 records the ending time stamp for the current event and enables the “Record” button 410 so another event can be recorded. The possible behaviors, antecedents and consequences can be customized using a system and method for customizing an event data recording apparatus in accordance with-an embodiment of the invention, described further below in the discussion of FIG. 9.

Multiple behaviors, antecedents and consequences can be recorded for a single event. Checkboxes are shown in FIG. 4 as the means for selecting the multiple behaviors, antecedents and consequences. For example, the behavior checkboxes 403 as shown include means for selecting “Vocalization” 431, “Screaming” 432, “Grabbing” 433, “Touching” 434, “Squeezing” 435, “Biting” 436 and “Furniture” 437 behaviors. In an embodiment of the present invention, the user interface can be customized by adding and removing behaviors from the list. Adding and removing behaviors the list is accomplished through the customization method described in FIG. 9 below.

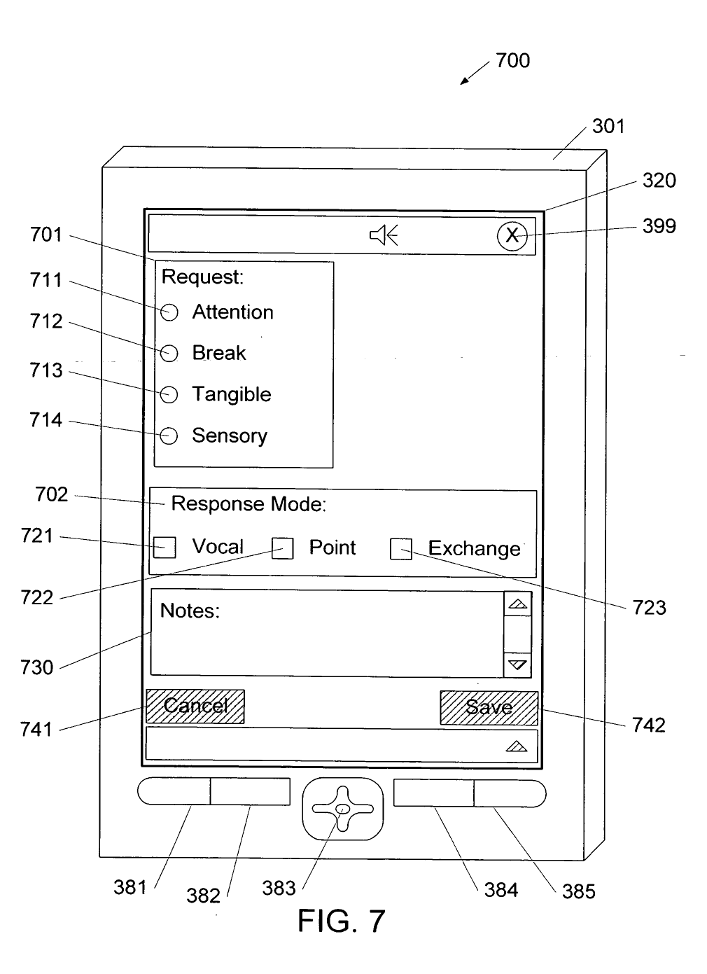

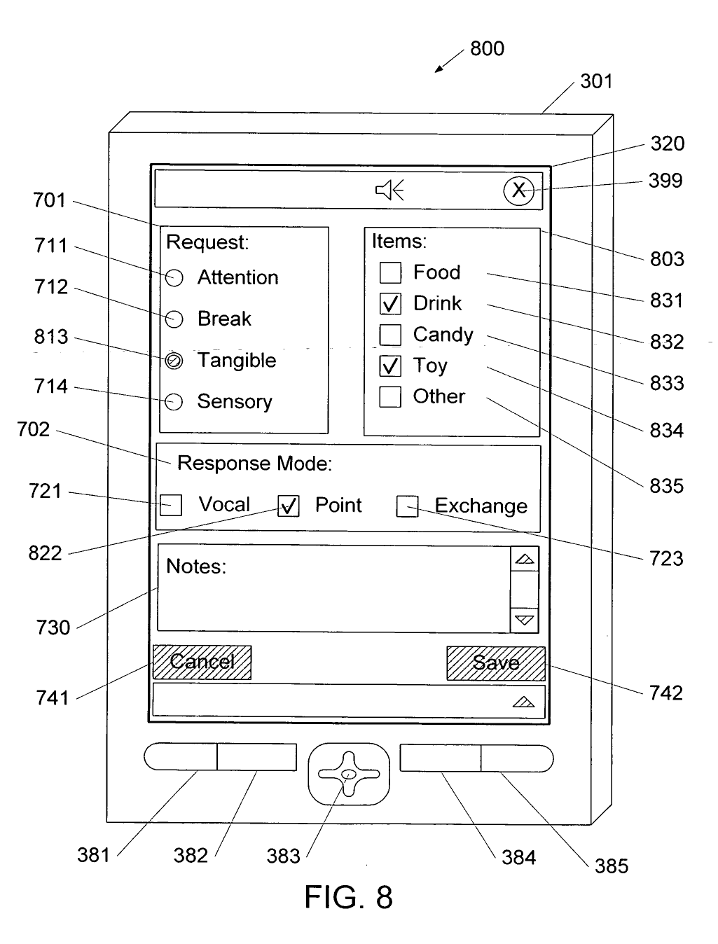

At the bottom of the behaviors list, there are two radio buttons representing “Comm Initiate” 406 and “Comm Redirect” 407. These radio buttons refer to behaviors that involve talking or the use of a Communication Device (not shown). For example, a Communication Device could be a specialized means for visually communicating through the use of icon tiles in accordance with various techniques. Typically, these icon tiles are small pieces of cardboard bearing the image and text of a piece of information that is useful for communication, such as an object, a desire, a feeling, or a place. For example, a student can hand someone the tiles for “eat” and “apple” to indicate that he wants to eat an apple. One commonly used standard for this form of communication is the Picture Exchange Communication System (PECS). As the student learns how to use the communication device more effectively, a system and method for collecting behavioral data in accordance with the invention is useful for tracking the student's progress. When a communication device behavior is selected, by selecting either Comm Initiate 406 or Comm Redirect 407, then the “Comm” button 413 is enabled because the device has been put into “Comm” mode. By selecting the “Comm” button 413, the user interface described below in the discussion of FIGS. 7-8 appears, thus providing an opportunity to enter and collect information about what the student asked for and how he asked for it. This feature will be described further below in the discussion of FIGS. 7-8, after the remaining features of the user interface shown in FIGS. 4-6 are described.

Antecedent checkboxes 404 include “Nothing” 441, “Demand” 442, “Peer” 443, and “Ant4” 444. Antecedents can be added to and removed from this list through the customization describe in FIG. 9. In the antecedent checkboxes list 404 as shown, the selection of “Nothing” 441 indicates that nothing observable occurred prior to the recorded behavior. This checkbox would be selected if, for example, the student started biting people for no apparent reason. If the collected data show that this scenario has been occurring at the same time every day for months at a time, then the data could indicate that the student's behavior could be attributed to something else, such as hunger. By noting such trends in the data, parents and teachers can look at the trends and try to understand what other circumstances and situations might be affecting the student's behavior.

The selection of “Demand” 442 indicates that someone made a demand of the student prior to the recorded behavior. An example of a demand is a situation where a teacher asks a student to do an assignment. The selection of “Peer” 443 indicates that a peer was interacting with the student prior to the recorded behavior. The selection of “Ant2” 444 relates to a customized antecedent that has been programmed into the data collection device, and shows an example of how the user interface can be customized to include user-defined antecedents.

Consequence checkboxes 405 include “Attention” 451, “Escape” 452, “Sensory” 453, “Nothing” 454 and “Bplan” 455. Consequences can be added to and removed from this list through the customization describe in FIG. 9. In the consequence checkboxes list 405 as shown, the selection of “Attention” 451 indicates that the student received some form of attention after the recorded behavior. Data that are collected on the antecedents and behaviors leading to a student getting attention are analyzed to determine whether patterns exist. For example, if a student consistently starts screaming (behavior/screaming) 432 during non-academic down time (antecedent/demand) 442, and the teacher gives the student a piece of candy to quiet him down (consequence/attention) 451, then the student is likely to continue the behavior because it accesses a desirable consequence. This kind of information is very useful in monitoring the student's progress in accordance with his IEP.

The selection of “Escape” 452 from consequence checkboxes 405 indicates that the student was allowed to escape after the recorded behavior. For example, if the teacher asked for the student to do a reading assignment (antecedent/demand) 442, and the student grabbed her (behavior/grabbing) 433, the teacher might then send the student to the Principal's office (consequence/escape) 452. The teacher can record these events in the data collection device by selecting the appropriate checkboxes. In an embodiment of the invention, a time stamp is automatically associated with the recording of events. The data that is collected is stored in the system, for example as a list or a database of events, that can be analyzed. In the scenario described above, if the student hated reading, then he might continue to grab the teacher in response to reading assignments so that he could escape the reading and go to the Principal's office. Understanding these sequences of behavior is important because often these students cannot speak and therefore cannot simply state what it is that they want. By examining trends in the student's behavior that come out of the data collected by using devices that operate in accordance with embodiments of the invention, it is possible to begin to understand what the student's likes, dislikes and motivators are.

The selection of “Sensory” 453 from consequence checkboxes 405 indicates that the student was given some sort of sensory experience after the recorded behavior.

The selection of “Nothing” 454 from consequence checkboxes 405 indicates that no observable consequence occurred following the behavior. For example, if a teacher does nothing (consequence) 455 in response to a student who screams (behavior) 432 following a demand (antecedent) 442, then the teacher would check the “Nothing” 454 box.

The selection of “Bplan” 455 from consequence checkboxes 305 indicates that a consequence relevant to the student's behavioral plan or IEP was presented. This is an example of how the consequence checkboxes 305 can be customized for a particular use, in this case, to provide an option for-selecting a consequence that-is associated with a particular student's IEP. By using the data collection device, both the student's behavior and the teacher's responses to that behavior can be tracked in order to determine whether or not the behavior plan is being followed, in addition to being able to analyze the collected data in order to determine whether the behavior plan is working. The easier it is to collect the data, the more data will be collected. And with more data, the functional behavior assessment can be done more effectively and efficiently, resulting in more efficient implementation of the student's IEPs and more efficient use of the teacher's time. Data collected using this methodology is more accurate because time stamps (not shown) are automatically recorded.

Also, changes in the environmental characteristics described in FIG. 3 above (Who, Location, Instruction, Delivery, Proximity, Condition, etc.) can be entered upon selection of the “E” button 402. (“E” refers to “Environment.”) Selecting the “E” button 402 pauses the behavior collection application so that the environmental changes can be recorded. (See FIG. 2, step 204.) Environmental changes can provide useful information for analyzing recorded behaviors. For example, by recording environmental information, an undesirable behavior that initially appears to be random might be traced to an environmental factor that is found to occur with each instance of the undesirable behavior. The ability to obtain such information is useful because it allows the parent or teacher to focus on the problem (in this case, some environmental factor) rather than continue to guess what the problem might be.

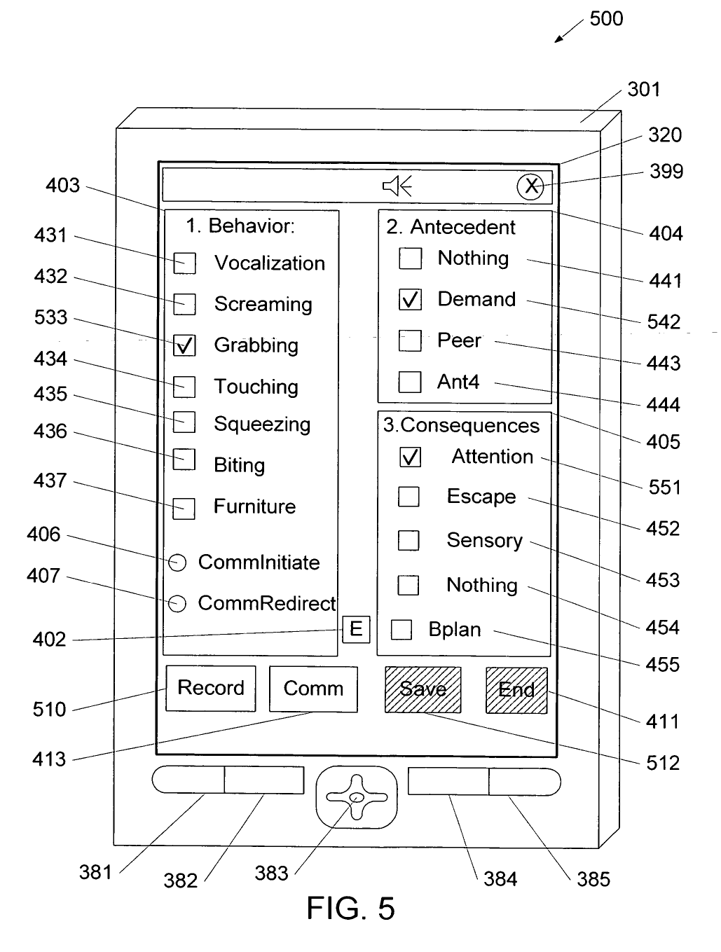

FIG. 5 is a diagram illustrating a system 500 for collecting behavioral information for multiple events in accordance with an embodiment of the invention, where the system 500 is shown as being implemented through a user interface on the display 320 on handheld device 301. The “Record” button 510 has already been selected and data collection has begun. (Notice that the “Save” button 512 and the “End” button 411 are in the active state, meaning that they are available to be selected, and the “Record” button 510 and the “Comm” button 413 are in the inactive state, meaning that they are not available to be selected. The “Record” button 510 and the “Save” button 512 have changed their state as a-result of the initiation of data collection. The “Record” button 510 is now inactive and the “Save” button 512 is now active. The “Comm” button 413 and the “End” button 411 have the same state as they did before data collection began. The “Comm” button 413 is still inactive and the “End” button 411 is still active.) As shown, the person who is collecting behavior data has selected the “Grabbing” behavior checkbox 533, the “Demand” antecedent checkbox 542, and the “Attention” consequence checkbox 551. For example, these data could reflect an event sequence where a teacher's demand 542 is followed by the student's grabbing behavior 533, which is then followed by the student getting some attention 551 from the teacher. A plurality of such events can be recorded through the use of the data collection device. The data is stored in the system and can be downloaded for use in functional analysis.

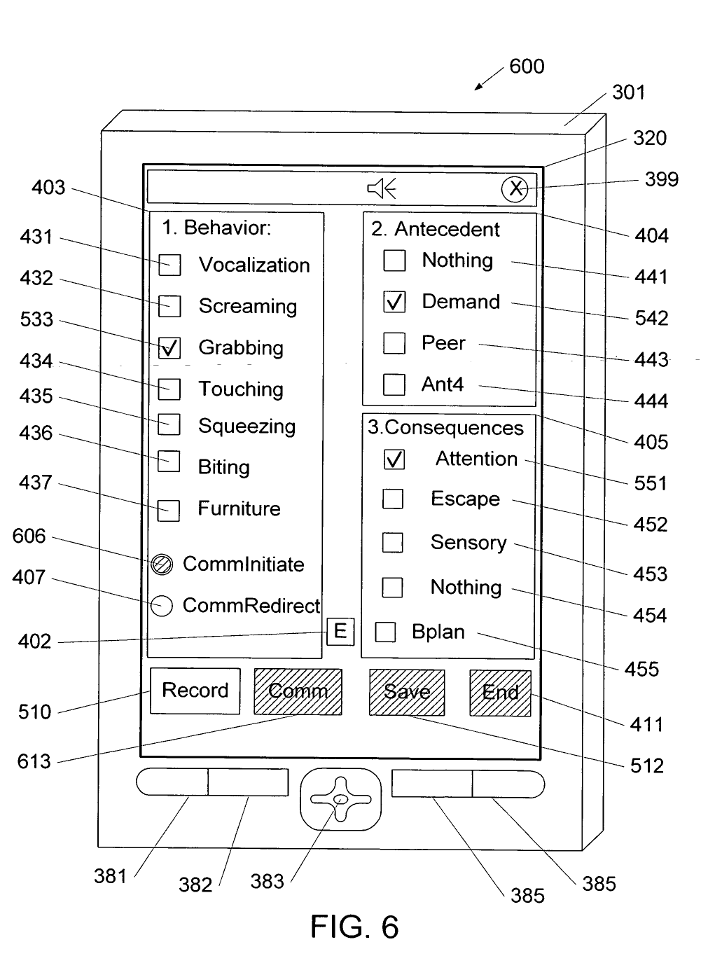

FIG. 6 is a diagram illustrating a system 600 for collecting behavioral information for multiple events in accordance with an embodiment of the invention, and is shown as being implemented through a user interface on a display 320 of handheld device 301. FIG. 6 shows how additional information about a student's communication behaviors can be collected during an event. In this case, the student has initiated appropriate communication by using his communication device. The person collecting the data has entered this information by selecting the “Comm Initiate” radio button 606. Selecting the “Comm Initiate” radio button 606 puts the data collection device into “Comm” mode, as shown by the now active “Comm” button 613. Selecting the “Comm” button 613 allows for the user to enter additional data around the communication behaviors initiated by the student, and is described below in the discussion of FIGS. 7-8. Notice that the “Comm” button 613, the “Save” button 512 and the “End” button 411 are in the active state, meaning that they are available to be selected, and the “Record” button 510 is in the inactive state, meaning that it is not available to be selected.

FIG. 7 is a diagram illustrating a system 700 for collecting communication behavior information in accordance with an embodiment of the invention, and is shown as being implemented through a user interface on a display 320 of handheld device 301. In this example, the user has selected the “Comm” button 613 in order to enter additional data relating to a student's communication book behaviors described above in the discussion of FIG. 6. The user interface includes radio buttons 711-714 associated with a plurality of possible request types. The Request types radio buttons include an “Attention” request 711, a “Break” request 712, a “Tangible” request 713, and a “Sensory” request 714. Notice that these are similar to the consequence checkboxes 405. Consequences are a reaction to a behavior. One desirable goal is to teach the student to communicate (and get what he wants) by engaging in an appropriate communication behavior (possibly by an alternative communication mode or device) to access a desirable consequence. This new, appropriate communication behavior would replace an inappropriate behavior that previously accessed the same consequence. For example, if the student is taught to initiate by handing the teacher a picture of “drink” and if this is followed by giving him a drink (consequence), the student now has an appropriate communication behavior asking for a drink in his repertoire. As this behavior is strengthened, the student will no longer need to rely on inappropriate behaviors to access a drink. The specifics of this communication behavior can be recorded by using the “Comm” feature.

The response mode can be recorded by using the response mode module 702. In an embodiment of the invention, a user can input data to the response mode module 702 by selecting one of the “Response Mode” check boxes 721-723. For example, if the student responds to the teacher by speaking, the “Vocal” response mode check box 721 is selected so that this behavior is recorded. If the student responds to the teacher by pointing at something, then the “Pointing” response mode check box 722 is selected so that this behavior is recorded. If the student responds to the teacher by exchanging a picture or icon from his communication book, then the “Exchange” response check box 723 is selected so that this behavior is recorded.

One goal is to teach the student an appropriate method to access what he wants. For example, if the student consistently gets attention by presenting the teacher with a picture from his communication book, when he wants something, he will begin to engage in that behavior more frequently. This point is described in further detail in the discussion of FIG. 8. An optional notes field 740 may be included-to provide a place for additional input. Also, a “Save” button 752 and a “Cancel” button 751 are included and shown as being active so that the user can decided to save the input or to cancel and not save the input.

FIG. 8 is a diagram illustrating a system 800 for collecting communication behavior information in accordance with an embodiment of the invention, and is shown as being implemented through a user interface on a display 320 of handheld device 301. System 800 is useful in situations where a student has presented his teacher with a communication behavior that is being recorded. In this example, the “Tangible” Request radio button 813 has been selected in order to record data that the student has made a request for a tangible. The “Drink” item checkbox 832 and the “Toy” item checkbox 834 have been selected in order to record data that the student's “Tangible” request was for a toy and a drink. The “Point” response mode checkbox 822 has been selected to record data that the student has communicated his desire for the drink and the toy by pointing to both tangible items. If the student had instead selected a picture from his communication book, for example, the picture indicating “drink”, then the “Exchange” response mode checkbox 723 would have been selected instead, to record the information that the student had used the picture exchange method for indicating to the teach what it was he wanted. Similarly, if the student had vocalized his desire for a toy by speaking up, then the “Vocal” response mode checkbox 721 would have been selected in order to record the student's action of telling his teacher what he wanted. Through this data collection method, interested parties such as teachers, parents, school psychologist, OT, SLP, and other care providers can obtain information relating to how the student's behavior is developing over time. This information can be used for helping to adjust the student's IEP. It is to be noted that the use of reference numbers that are the same in a previous figure is merely intended to indicate that the state of the particular user interface item has not changed from its state in the previous figure. For example, the “Vocal” response mode checkbox 721 is in an unselected state in both FIG. 7 and FIG. 8. The “Tangible” request radio button 713 is unselected in FIG. 7 whereas the “Tangible” request radio button 813 in FIG. 8 is selected.

FIG. 9 is a flow diagram 900 illustrating a method for customizing a system for collecting behavioral information in accordance with an embodiment of the invention. In an embodiment of the invention, this method is performed on a desktop system 111 and the results are loaded onto a portable device 101 such as a handheld through a synchronization process. In an embodiment of the invention, a configuration is selected for customization, step 901. Then a form type is selected, step 902. A plurality of forms may be customized, including an Observation Settings form, a Behavior Recording form, and an Additional Communication form. A check is performed to determine if the selected form exists, step 903. If the form does not exist, then a new one can be created, step 904. If the selected form already exists, then the form fields may be edited, step 905. A determination is made as to whether editing is complete, step 906. If there are more forms to edit, step 907, then another form may be selected for editing, and processing continues at step 902. If there are no more forms to edit, then processing continues at step 908. If editing is complete, then a choice is made as to whether to save the edits, 908. If edits are to be saved, then the configuration is updated. If edits are not to be saved, then it is possible to revert to the previously existing configuration, step 909.

In an embodiment of the invention, the customization process may start by clearing an existing configuration. This could begin with a request for a new design configuration or by starting the designer. The customization process could also start by loading an existing configuration or by reverting to a stored configuration. In the determination as to whether the requested form exists, step 903, the input focus can be shifted to the requested form, or if the form does not exist, the requested form could be created and then populated from the current configuration.

In an embodiment of the present invention, the step of editing form fields, step 905, can include determining a field type, such as a dropdown box, a check box or a radio button. In the case where the field type is a dropdown box, the customizing method can show existing list items and manipulation controls. If the field type is a check box or radio button, the customizing method can show an editable text box in front of the check box or the radio button.

In an embodiment of the invention, when the editing has been completed at step 906, a determination can be made as to whether the manipulation controls are shown, and if they are, the controls can be hidden before moving on to the next step of hiding the editable text or item list and updating the controls. If the manipulation controls are not shown, then it is not necessary to hide them before moving on the step of hiding the editable text or item list and updating the controls.

In an embodiment of the invention, saving the edits, step 908, can also include a step of determining whether a file has already been specified, and if not, a request could be made for a file name. If a file name is given, a determination can be made as to whether the file exists. If the file exists, a choice can be made as to whether to overwrite and save the configuration to/over the existing configuration file. If the file does not exist, then the configuration can be saved to a new file.

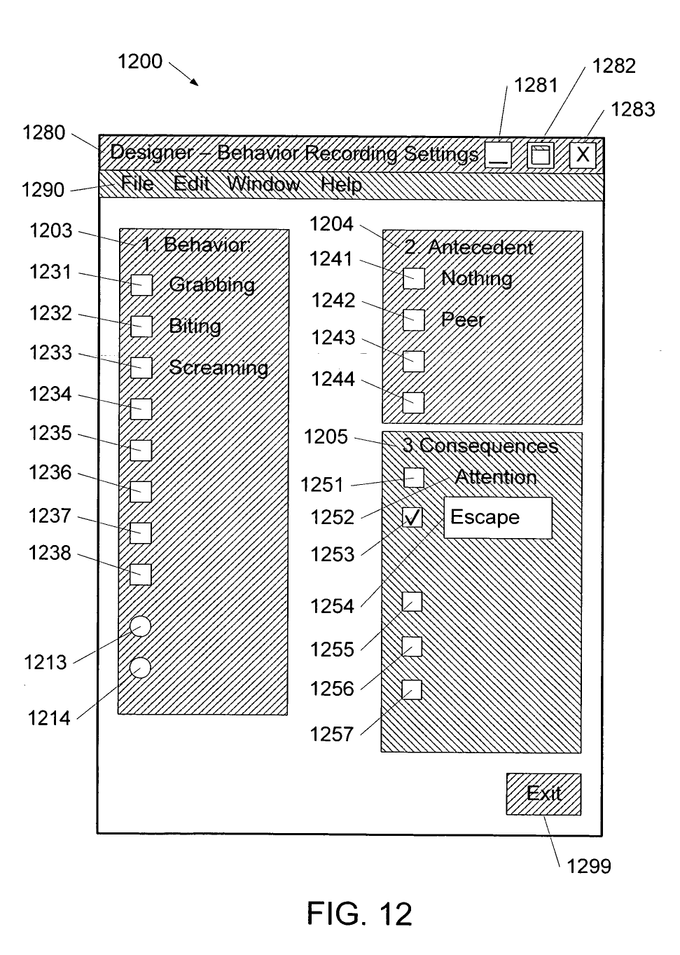

See FIGS. 12-14 for examples of a user interface that is used for designing and customizing forms in accordance with an embodiment of the invention.

FIG. 10 is a flow diagram 1000 illustrating a method for analyzing behavioral data in accordance with an embodiment of the invention. A raw data file containing behavioral data is selected, step 1001. The data are processed by calculating sequential relations between behaviors, step 1002. In general terms, a sequential relation between two entities reflects the notion of how the occurrence of one of the entities might be related to occurrences of the other. In embodiments of the present invention, these entities are typically events and behaviors, but these entities could also be other sorts of “non-point-in-time” entities such as attributes, for example poverty and illness. The way sequential relations are used is that one typically hypothesizes a sequential relation between entities and looks to statistical measures to either support or refute the hypothesis. For example, in an embodiment of the invention, data are collected and analyzed in order to form a hypothesis about elements contributing to the occurrence of a student's behavior, and statistical measures on the data are used to either support or refute the hypothesis. One purpose for such analysis is to attempt to find patterns in a student's behavior in order to track the student's progress and adjust his IEP in accordance with his progress. Since some special education students, especially autistic children, may find it difficult to articulate what they want, or may behave in ways that a teacher or caregiver might not understand, such analysis may be useful in helping to find trends in the student's behavior so that teachers and caregivers can react to the student in a more effective way.

Depending on how the data collection device was customized, it is possible for the data to be associated with an observation period. For example, the observation period could be the fixed period of time during which a student is in a particular teacher's class. It is also possible for the data to be associated with an activity or instruction. For example, the activity could be a segment of class associated with a particular subject of instruction, for example, when the teacher is presenting a student with a reading assignment. If the data were collected during a particular observation period, a rate of each behavior can be determined over the course of the observation period, step 1003. Alternatively, if the data were collected during an activity, then a rate of behavior can be determined over the course of the activity, step 1003. Numerous raw data files can be collected on a plurality of students over different observation periods and instruction/activity periods. These data files can be stored in memory for further analysis and comparison purposes.

Additionally, data files that are created by two different users of the data collection device (also known as “observers”) can be compared, step 1004, if desired, an inter-observer reliability value can be calculated, step 1005. Furthermore, the sequential relations and rates of behavior can also be used for generating reports and graphs, step 1006, that can be used for generating useful statistics and for tracking a student's progress against his IEP.

FIG. 11 is a flow diagram 1100 illustrating a method for automated instruction for a method for collecting and analyzing behavioral data in accordance with an embodiment of the invention. An instructional video is played on the desktop system 111 in order to show a prospective user how to enter data into the portable data collection device 101, step 1101. The instructional video typically shows a specific predetermined scenario such as a behavioral event, for which the user is to enter behavioral data into the data collection device 101. The predetermined scenario is associated with a plurality of expected input values that match up with the input that would be expected of a user who has recorded the scenario correctly. The data collection device 101 receives the input from the user by recording behavior events, step 1102, in accordance with methods such as those described in the discussion of FIGS. 2-8. Typically the user is a teacher who is learning how to use the portable device for a classroom of students for which she needs to enter behavioral data. In step 1103, the user's scoring of the behavior event from step 1102 is compared to the expected input according to the instructional video step 1101. A determination is made as to whether the user scored the event correctly, step 1104. If the user has scored the event correctly, then processing continues at step 1105, where a next instructional video is played on the desktop system 101. If the user has not scored the event correctly, then a determination is made as to whether a remedial video clip is to be played, step 1106, and if so, then a remedial video is selected for playback on the desktop, step 1107. If remedial video playback is not selected, then a provide feedback option is selected, step 1108. In an embodiment of the invention, the feedback can be provided in the form of instructional text, step 1109, or annotated video, step 1110.

FIG. 12 is a diagram illustrating a user interface 1200 for customizing a behavior recording form in a system for collecting behavioral data in accordance with an embodiment of the invention. As shown, the customization can be done through a WYSISWYG (what you see is what you get) in which a user can select desired checkbox items, radio button items and associated text. User interface 1200 includes a title bar 1280 shown as having a title of “Designer—Behavior Recording Settings.” This customization module allows the user to select desired behavior recording settings to be shown to the user of the behavior information collection systems shown in FIGS. 4-6. Title bar 1280 can include typical window controls as known in the art, for example, “minimize” 1281, “restore down” 1282, and “close” 1283. Underneath the title bar, the user interface 1200 may also include a typical menu bar 1290 which includes menu items such as File, Edit, Window and Help, and an “Exit” button 1299. By using the “Designer—Behavior Recording Settings” user interface 1200, the user can select desired Behaviors 1203, Antecedents 1204 and Consequences 1205 to be shown on the user interface of the behavior information collection systems shown in FIGS. 4-6. In this example, the user has chosen to include the Behaviors 1203 of “Grabbing” 1231, “Biting” 1232, and “Screaming” 1233. The remaining checkboxes 1234-1238 have not been customized to include additional Behaviors. Similarly, the radio buttons 1212-1214 have not been customized to include the “CommInitiate” 406 and “CommRedirect” 407 features. The user has chosen to include the Antecedents 1204 of “Nothing” 1241 and “Peer” 1242. The remaining checkboxes 1243-1244 have not been customized to include additional Antecedents. The customizing user has also chosen to include the Consequences 1205 of “Attention” 1251-1252 and “Escape” 1252-1253. The remaining checkboxes 1255-1257 have not been customized to include additional Consequences. The user activates the ability to edit this particular line item within the “Consequences” list 1205 by clicking on the check box 1253. The check mark in check box 1253 indicates that this field is now active for customization, as is shown by the white box 1254 into which the user has entered the word “Escape.” This is how the user can add the “Escape” item to the list of Consequences 1205. The “Escape” consequence 452 will now show up in behavior data collection systems 400, 500, 600 as shown in FIGS. 4-6. This particular method of customizing the user interface is shown by way of example, and can be implemented in other ways. It should be noted that the number of user customizable elements, such as check boxes and radio buttons, is not restricted to the number shown, but can also be customized to more or less than what is shown.

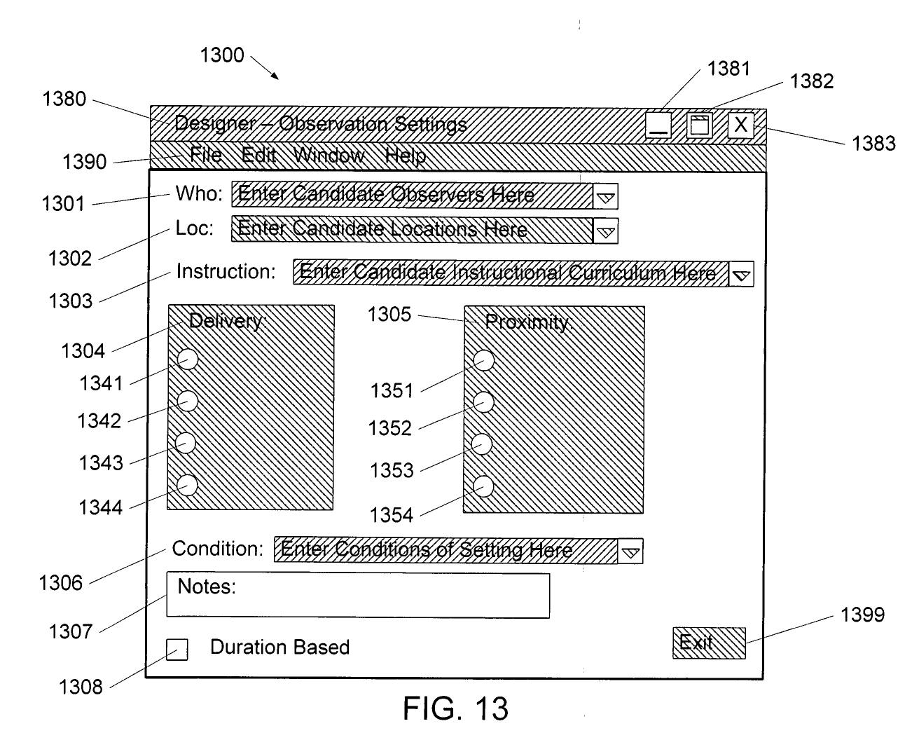

FIG. 13 is a diagram illustrating a user interface 1300 for customizing an observations setting form in a system for collecting behavioral data in accordance with an embodiment of the invention. User interface 1300 includes a title bar 1380 shown as having a title of “Designer—Observation Settings.” This customization module allows the user to select desired observation settings to be shown to the user of the behavior information collection system shown in FIG. 3. Title bar 1380 can include typical window controls as known in the-art, for example, “minimize” 1381, “restore down” 1382, and “close” 1383. Underneath the title bar, the user interface1300 may also include a typical menu bar 1390 which includes menu items such as File, Edit, Window and Help, and an “Exit” button 1399.

To customize the “Who” setting 1301, the user can enter candidate observers. The candidate observers are the people who will be collecting the behavioral data on the student, for example, the student's parents and teachers. To customize the “Location” setting 1302, the user can enter candidate locations. Candidate locations indicate where the observers will typically be making their observations. For example, a “teacher” candidate is likely to be making his observations of the student at school rather than at the student's home. In this case, the customizing user would enter “school” in the “Location” setting.

To customize the “Instruction” setting 1303, the user can enter candidate instructional curriculum that is relevant to the student. This can include for example, a particular reading, writing or mathematics curriculum, a curriculum that is consistent with the student's IEP, or a customized Bplan consequence 455. To customize the “Delivery” setting 1304 that appears on the behavioral data collection system 300 shown in FIG. 3, the user can enter desired settings to be associated with radio buttons 1341-1344. To customize the “Proximity” setting 1305 that appears on the behavioral data collection system 300 shown in FIG. 3, the user can enter desired settings to be associated with radio buttons 1351-1354. The user can also customize the “Condition” settings 1306, which appear, for example, on the behavioral data collection system 300 as dropdown list 307. The notes field 1307 and the “Duration Based” checkbox 1308 are shown as being part of the data collection form shown in FIG. 3 but they are not shown as being customized. It should be noted that the number of user customizable elements, such as check boxes and radio buttons, is not restricted to the number shown, but can also be customized to more or less than what is shown.

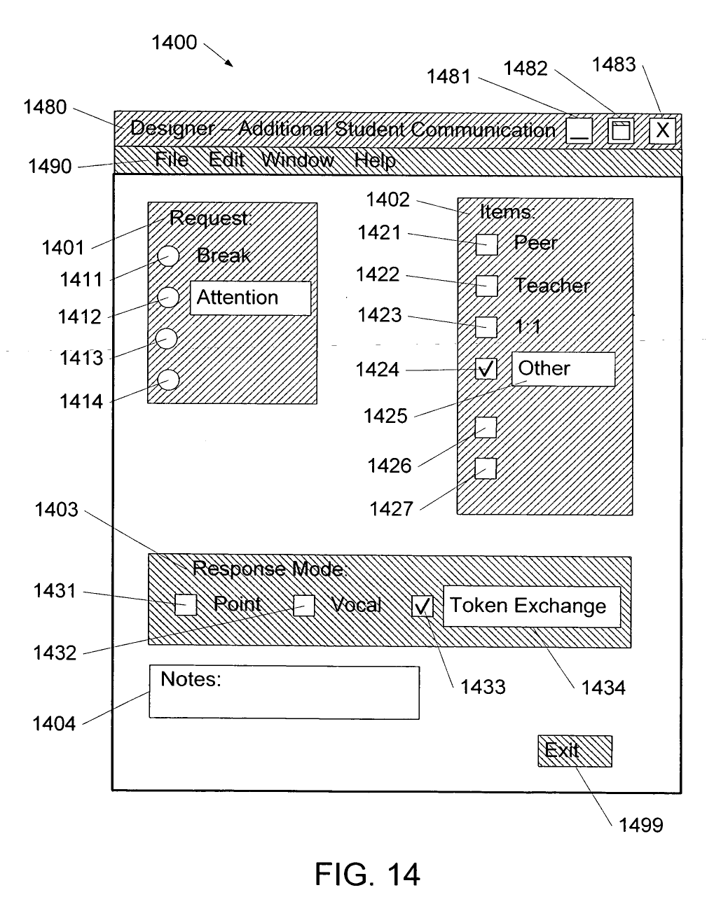

FIG. 14 is a diagram illustrating a user interface 1400 for customizing an additional communications form in a system for collecting behavioral data in accordance with an embodiment of the invention. User interface 1400 includes a title bar 1480 shown as having a title of “Designer—Additional Student Communication.” This customization module allows the user to select desired observation settings to be shown to the user of the communication behavior information collection systems shown in FIGS. 7-8. Title bar 1480 can include typical window controls as known in the art, for example, “minimize” 1481, “restore down” 1482, and “close” 1483. Underneath the title bar, the user interface1400 may also include a typical menu bar 1490 which includes menu items such as File, Edit, Window and Help, and an “Exit” button 1499. To customize the “Request” setting list 1401 that appears on the behavioral data collection systems 700 and 800 shown in FIGS. 7-8, the user can enter desired settings to be associated with radio buttons 1411-1414. The user activates the ability to edit this particular line item within the “Request” setting list 1401 by clicking on the space to the right of radio button 1412. This field is now active for customization, as is shown by the white box into which the user has entered the word “Attention.” This is how the user can add the “Attention” item to the “Request” list 1401. The “Attention” request 711 will now show up in behavior data collection systems 700 and 800 as shown in FIGS. 7-8. This particular method of customizing the user interface is shown by way of example, and can be implemented in other ways.

To customize the “Items” setting 1402 that appears on the behavioral data collection system 800 shown in FIG. 8, the user can enter desired settings to be associated with check boxes 1421-1427. The user activates the ability to edit this particular line item within the “Items” setting list 1402 by clicking on the check box 1424 or clicking on the space, shown as a text entry field 1425, to the right of check box 1424. This field is now active for customization, as is shown by the white box into which the user has entered the word “Other.” This is how the user can add the “Other” item to the “Item” list 1402. The “Other” item 835 will now show up in behavior data collection system 800 as shown in FIG. 8. This particular method of customizing the user interface is shown by way of example, and can be implemented in other ways.

To customize the “Response Mode” setting 1403 that appears on the behavioral data collection systems 700 and 800 shown in FIGS. 7-8, the user can enter desired settings to be associated with check boxes 14311-1433. The-user activates the ability to edit this particular line—item within the “Response Mode” setting list 1403 by clicking on the check box 1433 or by clicking on the space 1434 to the right of check box 1433. A text entry field 1434 is now active for customization, as is shown by the white box into which the user has entered the word “Token Exchange.” This is how the user can add the “Token Exchange” mode to the “Response Mode” list 1403. The “Token Exchange” response mode 723 will now show up in behavior data collection systems 700 and 800 as shown in FIGS. 7-8. This particular method of customizing the user interface is shown by way of example, and can be implemented in other ways. It should be noted that the number of user customizable elements, such as check boxes and radio buttons, is not restricted to the number shown, but can also be customized to more or less than what is shown. A “Notes” text field 1404 is shown as being part of the user interface 1400 but is not being customized in this example.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A method for collecting event data, comprising:
recording a behavior associated with an event;
recording an antecedent associated with the event, wherein the antecedent occurs prior to the behavior; and
recording a consequence associated-with the event, wherein the consequence occurs after the behavior.

2. The method of claim 1 wherein data are collected for a plurality of events, the data associated with each event including at least one antecedent, at least one behavior and at least one consequence.

3. A system for collecting event data, comprising:
a behavior recording module for recording at least one behavior parameter associated with an event;
an antecedent recording module for recording at least one antecedent parameter associated with the event, wherein the antecedent occurs prior to the behavior; and
a consequence recording module for recording at least one consequence parameter associated with the event, wherein the consequence occurs after the behavior.

4. The system of claim 3, further comprising a user interface module.

5. The system of claim 4, wherein the user interface module is predefined in accordance with a plurality of profile parameters associated with an individual.

6. The system of claim 4, wherein the user interface module includes a plurality of selectable checkboxes for recording the parameters associated with the event.

7. The system of claim 4, wherein the user interface module is predefined in accordance with a language parameter.

8. The system of claim 3, further comprising a note recording module for recording at least one note associated with a data collection period.

9. The system of claim 3, further comprising a communication recording module for recording at least one communication behavior associated with an event.

10. The system of claim 9, further comprising a note recording module for recording at least one note associated with the communication behavior.

11. A method for customizing an event data recording apparatus, comprising:
downloading a profile associated with an individual, the profile including:
a plurality of behavior parameters, wherein the behavior parameters relate to behavioral data associated with an event;
a plurality of antecedent parameters, wherein the antecedent parameters relate to antecedent data associated with an event;
a plurality of consequence parameters, wherein the consequence parameters relate to consequence data associated with an event;
associating a label to each profile parameter; and
associating the label with a checkbox, wherein the associated profile parameter is selected in response to the selection of the checkbox.

12. The method of claim 11, wherein the individual profile further includes a plurality of communication information parameters, wherein the communication information parameters relate to communication information associated with an event.

13. The method of claim 12, wherein the communication information parameter is associated with a request for attention.

14. The method of claim 12, wherein the communication information parameter is associated with a request for a tangible.

15. The method of claim 12, wherein the communication information parameter is associated with a determination as to whether an individual spoke.

16. The method of claim 12, wherein the communication information parameter is associated with a determination as to whether an individual gestured.

17. The method of claim 12, wherein the individual profile further includes a plurality of data associated with an online functional assessment interview.

18. A customization module for an event data recording apparatus, comprising:
a profile parameter module for storing a plurality of parameters contained in a profile associated with an individual; and
a data input screen setup module for associating the plurality of profile parameters with a plurality of checkboxes, the checkboxes being selectable in accordance with the event data being recorded.

19. A method for analyzing behavioral data, comprising:
receiving a plurality of behavioral data during a data collection period, wherein the plurality of behavioral data include a plurality of behaviors, each behavior having an associated antecedent and an associated consequence; and
determining a plurality of sequential relations between behaviors.

20. The method of claim 19, wherein the data collection period is associated with an observation period and further comprising:
determining a rate of the behavior per observation period.

21. The method of claim 19, wherein the data collection period is associated with an activity, and further comprising:
determining a rate of the behavior per activity.

22. The method of claim 19, wherein:
a first plurality of behavior data collected by an observer are contained in a first data file;
a second plurality of behavior data collected by the observer are contained in a second file; and
the first data file and the second data file are compared to determine an inter-observer reliability.

23. A method for analyzing and reporting behavioral data, comprising:
selecting a behavioral data file, wherein the behavioral data file includes a plurality of events, wherein:
a first event includes a first behavior and at least one of a first antecedent associated with the first behavior and a first consequence associated with the first behavior; and
a second event includes a second behavior and at least one of a second antecedent associated with the second behavior and a second consequence associated with the second behavior;
determining a sequential relation between antecedents, behaviors and consequences;
determining the rate of a behavior;
determining the duration of the behavior; and
comparing the sequential relation determination and the duration determination to a plurality of protocols and a plurality of goals included in an individualized education plan (IEP).

24. An automated training method for demonstrating use of a data collection device, comprising:
playing a first instructional video on a display device, wherein the instructional video displays a first expected input;
determining whether a first behavior event input recorded on a data collection device corresponds with the first expected input;
if the first behavior event input corresponds with the first expected input, selecting a second instructional video on the display device; and
if the first behavior event input does not correspond with the first expected input, playing a remedial video on the display device.

25. The automated training method of claim 24, wherein the remedial video is the first instructional video.

26. The automated training method of claim 24 wherein the remedial video is played in accordance with a remedial instruction indicator.
